(19) United States
(12) Patent Application Publication
(10) Pub. No.: US 2006/0173733 A1
(43) Pub. Date: Aug. 3, 2006

(54) System and method for centralized parking management

(76) Inventor: Mark Fancher, Chicago, IL (US)

Correspondence Address: DLA PIPER RUDNICK GRAY CARY US LLP, P O BOX 64807, CHICAGO, IL, 60664-0807, US

(21) Appl. No.: 11/326,756

(22) Filed: Jan. 6, 2006

Related U.S. Application Data
(60) Provisional application No. 60/641,978, filed on Jan. 7, 2005.

(51) Int. Cl. G07B 15/00; B60R 25/00; G08G 1/14

(52) U.S. Cl. 705/13; 340/5.7; 340/932.2

(57) ABSTRACT

A method and system for the full automation of parking garages and eliminating cashier or garage manager discretion in the calculation, collection, and reporting of revenue through a fully integrated enterprise-level system to control 1) monthly parking account management, billings and revenue reporting; 2) transient revenue control and reporting; and 3) on-site garage access control equipment.

### RELATED APPLICATIONS

This application claims priority from U.S. Provisional Patent Ser. No. 60/641978, filed Jan. 7, 2005.

### BACKGROUND OF THE INVENTION

1. Field of the Invention

The invention relates generally to a system and method for coordinating, streamlining and efficiently operating multiple parking facilities. In particular, this system method increases revenues and decreases operating expenses with respect to operation of parking facilities.

2. Background

Parking garages are operationally large, resource consuming businesses. Often, at many of the larger garages around the country, key activities are primarily handled by third-party operators, including account administration, billing and collections, managing access control, and garage marketing. Often, these third-party operators work under management contracts that provide for them to collect all revenues and pay out all expenses, then remit a monthly payment to the parking garage owner/manager after netting out their fee and pass-through expenses. Under this arrangement, the operators have a great deal of freedom to develop and apply their own policies, work processes, and systems.

Unfortunately, such systems are extremely flawed. There exist many operational deficiencies and, conversely, opportunities for additional revenue should the deficiencies be remedied. The largest deficiencies appear to be in the area of monthly parking administration, billing and collections. This deficiency arises from the dependency of the system on manual performance of these functions. This is primarily because 1) most parking operators fail to train and supervise their employees in the use of the controls and report capabilities of the systems; 2) the parking industry has a very high turnover rate; and 3) systems allow for considerable cashier manipulation of tickets and revenue.

### SUMMARY OF INVENTION

The inventive system and method eliminates cashier or garage manager involvement and discretion in the calculation, collection, and reporting of parking structure revenue through a fully integrated enterprise level system to fully automate 1) monthly parking account management, billings and revenue reporting; 2) transient revenue control and reporting; and 3) on-site garage access control equipment.

Moreover, this system provides a great cost saving by 1) eliminating on-site facility management computers and software, which will be replaced by an enterprise level control system and 2) streamlining and standardizing the functionality of the equipment. The system will ensure that customers are billed according to the terms of their entitlements, facilitate more accurate and efficient collections, reduce labor costs, and improve customer service. This standardization will increase parking revenue, and improve customer service. Under the inventive system and method, parking structure owners will be able to implement an enterprise level parking management system that will fully standardize and improve the management of parking for an entire portfolio of owned garages

The inventive method is more fully described in the detailed description of the invention.

### BRIEF DESCRIPTION OF DRAWINGS

Specific embodiments of the invention have been chosen for purposes of illustration and description, and are shown in the accompanying drawing, forming a part of the specification wherein:

FIG. 1 is a schematic representation of Phase 1 of the inventive system and method; and

FIG. 2 is a schematic representation of Phase 2 of the inventive system and method.

### DETAILED DESCRIPTION OF INVENTION

In the preferred embodiment of the invention, the Centralized Parking Management System (“CPMS”) is divided into two primary phases or sections. Phase I relates to the management of monthly parkers in a particular garage. Phase II concerns “transient” or one-time parkers in a particular garage. It should be understood that when the inventive method is generally described as relating to a single parking facility, the disclosed system can handle, and is intended to handle, multiple parking facilities. Further, while both phases of the disclosed method are intended to operate together, each can operate independently of each other. Each phase or section of the inventive method will now be discussed in further detail.

Phase I

In the first phase of the system, the parking garage owner internally manages and bills all monthly parking customers. By way of background, in the prior art systems, this revenue is usually billed by third-party parking operators, utilizing widely disparate platforms. In Phase I of the inventive method management is centralized in an enterprise level server and fully integrated with garage access control systems.

The garage Access Control System (“ACS”) includes one or more Access Control Devices (“ACD”) that are provided to each monthly parking customer. ACD activation and deactivation is initiated by CPMS and automatically enforced in the Access Control System. This would be accomplished through either real-time activation event notifications or, alternately, ongoing maintenance of a “white list”—a list of approved ACDs that would be downloaded on a daily basis. ACD events, such as entry and exit from a parking facility, in the Access Control System are transmitted to CPMS for the purposes of: 1) tracking monthly customer occupancy in the parking property; 2) determining most recent use of the facility by a particular parker (based on use of the ACD); and 3) auditing that ACDs in use in the facility are active and current in CPMS.

In the preferred embodiment of the invention, the Centralized Parking Management System and method integrates a number of existing or otherwise novel systems. For example:
Accounting Software—For parking garages and other parking structures that are under common ownership with multiple tenant office or residential buildings, the CPMS can consolidate parking charges onto existing tenant invoices, centralize billing and collections for other monthly customers, and utilize existing payment interfaces for lockbox and ACH payments.
Deal Approval Sheets—these track the progress of tenant leases from origination through negotiation, approval, and execution. One important feature of the CPMS is to track the parking-related lease terms, and quantify the parking concession, in parallel with the lease process. The specific integration includes the CPMS providing a user interface for inputting parking terms into the deal approval sheets. Upon deal execution, tenant contact and bill-to information would be linked to the finalized parking rate contract as created in CPMS.

The CPMS is also supported within a garage's existing service center infrastructure if utilized by the garage owner. Service centers will provide web and phone support for customers' monthly accounts, billing, and other related issues. Parking accounting and administrative functions, including the flow of data generated by the CPMS system, the accounting software and any other accounting system, as well as the reconciliation and distribution of parking revenue will be supported within the garage's existing accounting infrastructure. The CPMS can reside on any server. The CPMS system also provides online, self-service purchase and redemption of validations. This will allow the customer to have complete control of the validation process and for automated billing of tenants and other monthly customers for validation purchases. It is important to note that the cost for the service center and accounting functions would be offset by very significant annual savings in parking labor expenses and management fees.

Phase I of the inventive CPMS and method will perform the following activities and functions:
1) Manage monthly parkers—Customer Parking Administrators (“CPAs”) can access a primary entry point or portal to perform all monthly parking related management functions for their organization.
2) Add monthly parkers—CPAs can add parkers under the terms of the rate contract between the customer and the parking structure owner or under public rates. The CPMS will ensure the new parker has access to the parking property, collects appropriate transaction fees, and adds the parker to the recurring billing.
3) Cancel monthly parkers—CPAs can cancel parkers. The CPMS will enforce notice provisions of the contract, verify last use of the parking property by the parker, and prevent access after the effective date. Appropriate transaction fees are collected, the parker will be removed from recurring billing and any credits or refunds will be issued.
4) Manage billing and collections—The system is set such that on a set day each month, the CPMS will generate charges based on rates and customers in effect on the first day of the following month and transmit these charges to the accounting software billing system. CPAs will be able to review the details of parkers and rates—which are summarized on the monthly statement—through the CPMS. CPAs can also contact Customer Service through the CPMS. Credit card payments will be handled through the CPMS, and all other payments will be processed through the billing system. On a daily basis, the CPMS will examine the past due status of each parker and notify the Access Control System to activate or deactivate ACDs as appropriate. Clients that are past due for a specified period may be cancelled within the CPMS.
5) Generate Recurring Charges—At the beginning of each billing cycle, the CPMS will review each active contract and generate charges. The CPMS will apply the rules for group contracts, calculate the rates in effect, and determine taxes owed. The CPMS will create a record in the interface file format for billing, create an ACH charge or credit card draft for payment.
6) Review Statements—Through the web portal, the CPAs may access the prior 12 months of statements for their account. CPAs can also request assistance via a centralized service center.
7) Manage negotiated parking contracts—Parking Contract Managers or leasing agents in cases where parking terms are part of a tenant lease, may use the CPMS to evaluate potential parking deals prior to final execution. The CPMS will calculate and present the value of parking lease concessions. Once a deal is approved, the CPMS will incorporate the parking terms from the executed deal into the active billing system. The CPMS will regularly look for updates or expirations of rate contracts and depending on how the administrator sets up the contract, will either automatically make the adjustment or notify the Parking Contract Manager via an email for a manual update.
8) Create rate contract—Parking Contract Managers may establish special deals with clients as part of leases or for promotional purposes. These special deals are entered into the CPMS through the web portal. Information about the rate contract includes any special pricing available for monthly parking, as well as minimum or maximum parker allocations and pooling calculations.
9) Finalize parking terms—Once a deal is approved, either through leasing or a negotiated contract by the Parking Contract Manager, the Rate Contract must be finalized. Through the CPMS web portal, the Parking Contract Manager is able to enter the finalized parking terms, including updating the rates with any changes, establishing the beginning and ending dates of the contract, and specifying escalations that may occur during the life of the contract. In addition, any special rates for transaction fees and services can be defined in the system.
10) Update expiring parking terms—Prior to billing, the CPMS reviews all contracts to identify expiring terms and depending on the administrative settings, either updates the terms automatically or sends an email to the Parking Contract Managers informing them of the expiring contract. Those that are automatically updated will be billed according to their lease terms. The Parking Contract Manager will review terms that are not automatically updated and will adjust them directly through CPMS.
11) Optimize parking rates—Key indicators will include changes in demand generators, peak occupancy levels, turnover in monthly parkers, rates at competing parking properties, and relative stall values between monthly and transient products. The availability of certain parking products may be limited in order to make more stalls available for higher margin products, and promotional rates may be established based on information obtained through the CPMS.
12) Administer Parking Properties—Create and update parking property profiles. These profiles include property contact information, default business rule settings and other attributes. Identify the availability of attributes at each property, as well as establishing initial posted rates. Also, the system will identify parking tax authorities and rates for each property.
13) Configure parking products—Configure monthly parking products available at a parking property. Configuring a product includes establishing the base products and their availability at the garage, then defining value adding product features which may be associated with a premium price. In addition, the system designates which transaction/service fees are active at the parking property.
14) Manage access control devices—As a result of a direct interface between the CPMS and garage access readers, the system will facilitate full accounting for all active ACDs for a parking property at any time.
15) Process access control events—The CPMS will receive ACD events from the Access Control System located at the parking property in order to determine monthly parking occupancy, update parker records for the most recent use of the facility, and verify that ACD activation status between CPMS and the Access Control System are synchronized.
16) Open a public parking account—Potential parking customers may directly establish a parking account through the web. Contracts built this way will be limited to public or promotional rates, and must meet any restrictions on methods of payment, availability, and promotional restrictions. Customers will be able to locate available parking, select products of interest and establish payment methods in a manner similar to an eStore.

This systematic and centralized approach to monthly parking under Phase I of the inventive method and system will provide the garage owner with direct control over this income, and will support the goals of increased revenue, customer service, and operating efficiencies. In addition, the system will create consistent and reliable metrics, which will allow for detailed analysis and strategic management of the revenue. The system supports important business objectives by employing the following key elements:
Control over account billing, collections, and bank accounts
Enforcement of complex rate contracts (stand alone or embedded in tenant leases)
Customer self-service for parker registration, administration and statement review
Direct control over access control devices (“ACDs”)
Monthly revenue reporting directly into enterprise accounting systems in the current month
Consistent, reliable metrics, allowing for strategic asset management and revenue maximization.

Phase II

The second phase or section of the inventive system and method manages transient parker revenue via an enterprise level reporting system, and as previously discussed, replaces existing on-site garage access equipment with new technology that will fully automate control of garage access. The new equipment will fully integrate with the enterprise level system, and will feature automated cashiering via pay-on-foot stations. This revenue is currently collected by third-party parking operators, almost entirely by unskilled and low wage personnel, and with inconsistent and inadequate revenue controls. A centralized, automated system provides complete and direct control over this income, supporting the goals of increased revenue and customer service, and reduced operating costs. In addition, the system creates consistent and reliable metrics, which will allow for detailed analysis and strategic management of this revenue. This portion of the inventive system and method supports the important business objectives by leveraging the following key elements:
Control of transient customer access, rate calculation and revenue collection
Customer self service for transient parking payments and validation purchases
Increased revenue controls through elimination of manual cashier intervention and migration toward credit and debit cards as the primary payment method for transient parkers
Customer self-service for validation purchase, redemption and administration
Reduced garage cashier and management expenses
Transient revenue reporting directly into accounting software in the current month
Consistent, reliable metrics, allowing for strategic asset management and revenue maximization.
Customer self-service calculation and payment for transient parking charges.
Real-time reporting of daily transient activity directly into the enterprise level system. This will allow for immediate, accurate data on facility occupancy, monthly vs. transient utilization, and profitability.

Most garages are equipped with exit booths and fee computers, manned by cashiers employed by parking operators. Cashiers enter tickets into the fee computers, which calculate rates and generate revenue reports. This process is labor intensive and the revenue is very easy to manipulate. There are always instances of theft. The conventional industry solution to this arrangement is to install pay-on-foot machines. These machines calculate ticket values and allow for payment by cash or credit card. Parking operators manually collect cash from the machines and replenish the change vaults as required. The machines generate reports that are manually entered into the operators' revenue systems. The machines cost $60K to $75K each and are large, unattractive and difficult for customers to use. It would be inappropriate to place such a machine in the lobby of a Class “A” major office building, and because cash is still handled and the reporting is manual, an opportunity for theft remains.

Instead, the garage owner will identify an equipment manufacturer that can develop a pay-on-foot payment terminal that is compact, appropriate for building lobby installation (chrome/glass, etc.) and is simple in both design and function. It is anticipated that the payment terminals will contain a flat touch screen, a device for generating and processing machine readable code), a credit card acceptor and an entitlement printer, and that they will be networked with the enterprise system.

Phase II of the inventive CPMS and method will perform the following activities and functions:
1) Acknowledge customer entry into garage—Transient customers (defined as any cars presented to the entry lane without the presence of a valid monthly parker ACD) will be allowed entry to the garage only after the transient customer obtains a ticket or other identifier from a ticket issuer or other access device. The transient parker may also obtain an identifier by entering a credit card or having other electronic means of indemnification. The identifier will serve as the transient parker's temporary ACES. The ACD is recognized by the garages access control system (ACS) located at the entry gate(s).
2) Calculate length of stay and parking fee—Immediately before returning to their car, the customer will proceed to the pay-on-foot payment terminal and present her transient customer ACD (identifier) to the ACS, which is an integral part of the payment terminal. The system will read the ACD and calculate the fee owed. The payment terminal will be located in the building elevator lobby or another convenient, central location. Some buildings may require multiple payment terminals due to transient customer volume or garage layout.
3) Collect parking fee—After the fee has been calculated, the customer will pay the parking charge by inserting their credit card into the credit card reader, which will be an integral part of the payment terminal. The system will charge the customer's card for the parking fee owed and issue an entitlement. Additional payment methods, such as currency, debt card, or electronic transfer, for example, may be used in lieu of or in addition to a credit card payment.
4) Allow customer egress from garage—The system will associate the ACD with a paid parking transaction, and will allow the customer a reasonable period of time to return to their car and exit the garage. This period of time will be five to fifteen minutes, depending upon the size and configuration of the garage. Upon reaching the garage exit the system will accept the ACD and allow the customer to exit the garage.
5) Customer Pre-Paid Entitlement—Customers also have the option of pre-purchase units of entitlement via a pay-on-foot payment terminal. Customers will be required to charge the purchase to their credit card. The time units will be identified by machine-readable code, recorded to an ACD and the appropriate amount will be deducted from the ACD is presented to the garage exit system. The ACD will expire at the end of the prepaid time unit.
6) Self-service validation of transient entitlement—Customers may also validate guest entitlement ACD via the parking garage's CPMS website. Customers may validate all or part of their guests' parking charges. Customers log on to the CPMS website with the appropriate credentials, manually enter an entitlement identifier, Customer account code and then may choose to either validate all or part of their guests' parking charges. The parking charges are calculated from a rate table located on a garage server and the payment terminal, Guests pay for any balance due at either the pay-on-foot payment terminal or the exit payment terminal. An option for a printed receipt of payment will be available from both the web site interface and the payment terminal.
7) Payment of transient entitlement fee—The value of a transient entitlement ACD will be calculated the same way as a customer transient entitlement validation. Immediately before returning to their car, the customer will proceed to the pay-on-foot payment terminal and present their transient customer ACD to the ACS, which is an integral part of the payment terminal. The system will read the ACD code, calculate the fee owed, request payment amount, and provide payment option.
8) Report transient and validation revenue—All pay-on-foot payment terminals and exit verifiers will be on-line devices reporting to the enterprise system. All transient revenue collected will be captured in the system, and daily, weekly or monthly revenue activity may be reported on any day of the month.
9) Report garage occupancy and utilization—Real-time, on-line reporting will allow consistent and reliable metrics for garage occupancy, monthly vs. transient utilization, customer usage trends and other key drivers of garage profitability.

Regardless of which phase is utilized, the CPMS and method offers the following additional features:
1) Customer self-service—A web-based customer self-service system will allow customers to view account activity. This includes the number of active parkers, transactional activity, and statements with detailed drill-down capability. In addition, customers will be able to directly manage their parkers, including utilization of lease commitments and parker additions and deletions. The CPMS will ensure that account-related activity (i.e. parker additions and cancellations) and payment status is directly and promptly reflected on customers' accounts. This will directly interact with access card activation and deactivation. As a result, the current manual maintenance processes, performed by third party operators, will be eliminated. The CPMS will provide additional payment methods for customer convenience, and will provide auto-payment capabilities (via credit card or ACH) that eliminate the need for invoicing and streamline AIR processing.
2) Accounts Receivable—Many parking operations maintain large accounts receivable balances, some of which is written off as uncollectable. Often, unclear accounting on the part of the parking operator results in customer disputes over adding and deleting parkers, as well as lax lockout controls. The CPMS will address this by providing web-based, self-service capabilities to clients for managing their own parkers and reviewing their statement detail online as well as automatic payment mechanisms. The system will automatically connect payment status with activation/deactivation of cards in the Access Control System to implement lockout procedures for delinquent accounts.
3) Policy Standards—As a result of the business rules and features inherent in implementing a centralized, integrated Centralized Parking Management System, consistent standards and policies related to parking will be introduced and enforced. Several of these policies have been discussed earlier due to their significant impact on revenue. In addition to economic benefits, the system will raise and standardize customer service levels. Examples of standardized policies that will be integrated into CPMS include:
Notification policies for cancellations
   Lockout policies
   Rate approval policies
   Consistent billing dates
   Proration policies for monthly rates
   Standardized promotional offerings and approach
   Employee and supplier allocation and access rights
4) Streamlined workflows—Many of the work processes currently required to manage monthly and transient parking are manual, and include overlapping processes and duplication of efforts. Many work processes are undocumented, and work processes are inconsistent from location to location. In addition, employees turn over frequently and are often untrained or poorly trained. While in some instances revenue and other reports are system-generated, those reports are frequently manually transposed into rollup reporting systems. The system will significantly automate, streamline and standardize these work processes. Because the system operates at an enterprise level, the information flow is automatic, and the need for reconciliation or auditing will be greatly reduced.
5) Contract Compliance—The provisions of tenant lease agreements that are related to parking are very diverse and in some instances very complex. Due to deficiencies in parking operators' billing software and work processes, these parking terms are often mismanaged. Most operators do not have the systems and procedures to easily manage requirements such as maximum parking allocations, “must takes” or minimum parker requirements, pooling, and periodic rate escalations. The CPMS has identified these features and business rules as part of the system definition.
6) Abuse of Complimentary and Discount Parking—Under the present system, monthly accounts may be established with the billing either waived or billed at a significant discount off the established monthly rate. The CPMS will force control of discounted and complimentary rates by ensuring that appropriate management levels approve the rates, and by placing limits on the number of cards having access to these rates.
7) Below Market Rates—Active revenue management practices can have a significant effect on overall parking revenues. The CPMS provides metrics for analyzing parking rates, including comparisons of stall values by product (monthly, transient, early bird) and analysis of customer use patterns. The CPMS links with the Deal Approval process, providing visibility to the value of parking-related concessions and calculating the value of those concessions in the total deal economics.
8) Administrative Expense Reduction—By centralizing monthly parking, significant administrative responsibility will be removed from the third party operators. Typically, third party operators charge for these activities through accounting fees or bookkeeper labor allocations, garage manager oversight, as well as associated charges for software, printing, and postage.
9) Unbilled Active Cards—These garage access cards are actively used by customers, but are not associated with an active account billing. In most cases these cardholders are parking free of charge. The CPMS will ensure that any card issued is associated with an active, paid account, and will enforce card deactivation for all cancellations or unpaid accounts. In addition, direct integration of the CPMS with Access Control Systems will eliminate human intervention in the activation and deactivation of cards.
   Benefits:

A standardized, enterprise level solution to parking revenue management will maximize parking investment return and provide the garage owner with direct control over those parking activities that most immediately face their customers. This system integrates parking space leasing and monthly tracking, and returns revenue control from third-party operators back to the building owner and/or landlord. Specific benefits include:
Increasing parking revenue by ensuring that monthly parking allocations and rates are billed accurately and reflect the commitments made to tenants in their lease.
Reducing open accounts receivable balances by leveraging existing billing mechanisms to simplify customer billing and payment processing.
Maximizing monthly parking revenue by eliminating the abuse of monthly parking privileges, through complete control of all customers who have physical access to monthly parking areas.
Maximizing transient and validation parking rate calculation and revenue collection, by eliminating cashier ticket manipulation, miscalculation, theft and other slippage.
Maximizing revenue per stall by providing accurate and consistent metrics for establishing and managing rates, garage utilization and customer patterns.
Reducing parking cashier labor and site supervision costs through leveraging pay-on-foot parking payment solutions. Reducing parking administrative costs through centralized processing and leveraging existing billing systems.
Reporting of parking revenue in the current month, thereby eliminating current accrual and adjustment processes, which are administratively complex and leads to lapses in the integrity of revenue reporting.

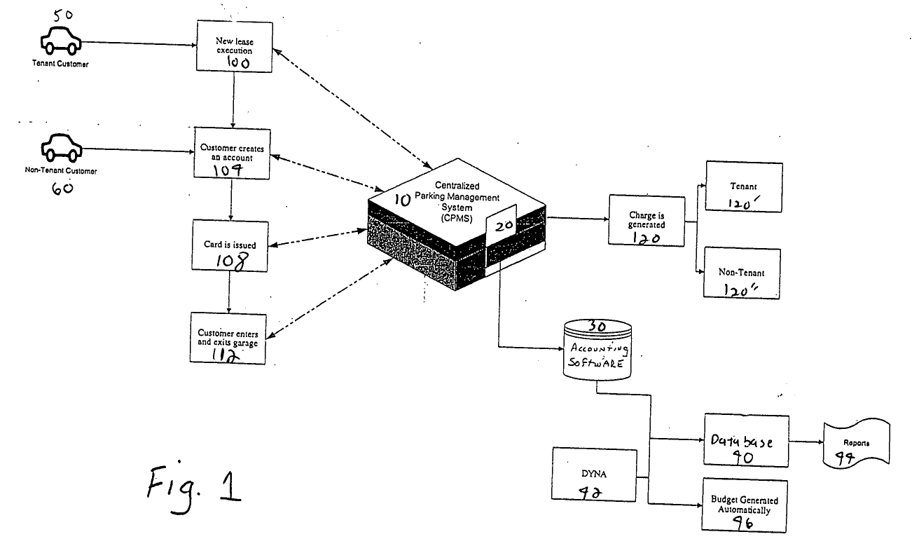

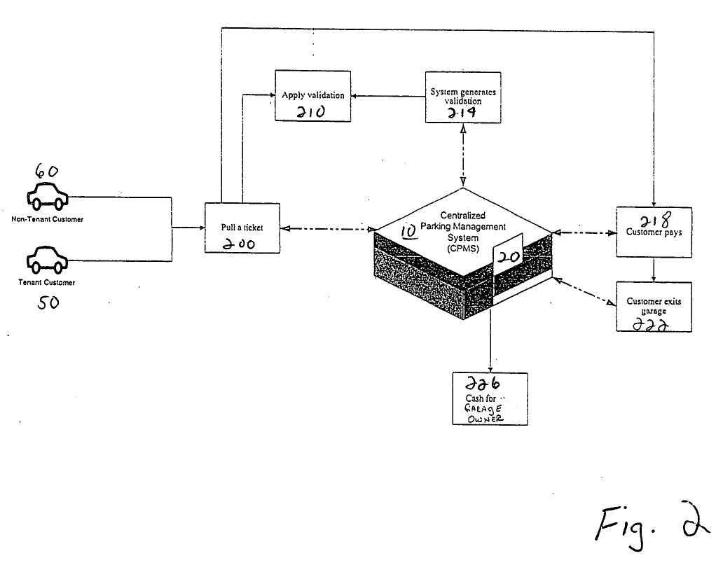

Referring now to FIGS. 1 and 2, the CPMS 10 can reside on any appropriate computer server 20. As is shown in FIG. 1, on the parker side of Phase I of the subject system and method, tenant customer 50 creates or enters into a new lease 100 for use of a particular parking facility (or group of facilities) and an new customer account 104 is created. A non-tenant customer 60 will create a new account 104. In either case a card or other Access Control Device (“ACD”) is created and issued to the customer 108. The card/ACD is used to enter and exit the garage 112. Steps 100-112, above, are communicated to server 20 of the CAMPS 10 and respective feedback and data is provided back from the CAMPS. Respectively, the CAMPS 10 generates a charge 120 for such services, either a charge to a tenant 120′ or non-tenant 120″. On the payment side, the CPMS 10 exports such customer and billing data to an accounting software module 30. Depending on the user, any customized or off-the-shelf accounting software 30 may be utilized-it is merely a question of choice of applicability for a particular user. Also tied into the system is a DYNA (Realm Business Solutions—Houston, Tex.) forecasting tool 42. DYNA is a comprehensive suite of sophisticated financial analysis tools for real estate asset and portfolio management and is used for preparing operating projections for commercial office, retail, industrial, apartment, and hotel properties on a cash, tax, or book basis, including current and predicted garage usage and usage patterns. Information from the accounting software 30 may or may not be processed by the DYNA software suite 42, but such information is exported to a database 40 for which client reports 44 may be created and/or a budget is generated 46.

Turning specifically now to FIG. 2, Phase II of the subject system and method, a tenant customer 50 or a non-tenant customer 60 enters a respective parking facility and obtains a temporary parking access control identifier/device (“temporary ACS”) from an automated dispenser 200 which is linked to the server 20 of the CPMS 10. The temporary parking ACS may take the form of a ticket containing a bar code or other machine readable code or may be the entry of the parker's credit card information into the dispenser or other entry device. It is further contemplated that other identifying technologies, such as RFID may be used to obtain a temporary ACS or other means for entering the parking facility. If offered by a building tenant, a validation is applied for 210 via the CPMS. The CAMPS 10 processes the request and electronically validates the temporary ACS 214, noting the validation in the system. Upon exiting the parking facility, the customer pays for parking and obtains an entitlement 218 and exits 222 upon confirmation of payment. As previously described in greater detail, above, the payment 218 and exiting 22 parameters are automatic and rely on little to no personal for execution. The payment is noted in the CAMPS 10 and the garage owner is tendered payment by the system for all parking in a designated period of time 226.

Also it should be noted in the preferred embodiment, broadband network connectivity is supplied through frame relay or DSL, depending on the user volume at the property although other communications methods, including wireless may be utilized. In the preferred embodiment, any typical development software can serve as the primary application development environment (ABE).

In addition to the structures, sequences, and uses immediately described above, it will be apparent to those skilled in the art that other modifications and variations can be made to the method of the instant invention without diverging from the scope, spirit, or teaching of the invention. Therefore, it is the intention of the inventors that the description of instant invention should be considered illustrative and the invention is to be limited only as specified in the claims end equivalents thereto.

I claim:

1. A system for centralized management of one or more parking garage structures, the system comprising:
a) a centralized computer server;
b) at least one entry and exit control device at each of the at least one parking garage;
c) at least one access control device for use by a parker in the at least one parking garage, each of the at least one access control device having a unique identifying signature and electronically operable and in communication with said entry and exit and control device;
d) means for generating a temporary access control identifier for a transient parker; and
e) means for paying a temporary access control identifier by said transient parker;
wherein elements b)-e) are in electronic communication with the centralized computer server.

2. The system of claim 1 further comprising at least one computer terminal at each of the at least one parking garage structures, each of said at least one computer terminals in electronic communication with said centralized computer server and said elements b)-e).

3. The system of claim 1 wherein the means for paying comprising a payment terminal located in said parking structure.

4. The system of claim 1 wherein the centralized computer server further comprises one or more modules selected from the group consisting of an accounting module, a forecasting module, a financial reporting module, a tax reporting module and a report generating module.

5. The system of claim 1 further comprising a means for validating said temporary access control identifier, said validation means in electronic communication with said central computer server.

6. The system of claim 5 wherein the means for validation is a device capable of reading a machine readable code.

7. The system of claim 3 wherein said payment terminal further includes one or more features selected from the group consisting of a credit card reader, a debit card reader, and means for accepting currency.

8. A method of centralized management of at least one parking structure, the method comprising:
a) providing a centralized computer server;
b) providing at least one entry and exit control device at each of the at least one parking structure,
c) providing at least one access control device for use by non-transient parkers in the at least one parking structure, each of the at least one access control devices having a unique identifying signature and electronically operable and in communication with said entry and exit and control device
d) establishing a customer account for each of said access control devices;
e) communicating information on said customer account to and from said central processor;
f) reading said unique identifying signature of each of said at least one access control devices upon entry to said parking structure;
g) generating a charge payable by said parking customer; and
h) generating a report of all transactions by said customer.

9. The method of claim 8 further comprising the step of activating said access control device upon validating customer information.

10. The method of claim 8 further comprising the step of deactivating said access control device upon a terminating event by said non-transient parker.

11. The method of claim 8 further comprising the step of generating a customer activity report for each of said customers individually or in the aggregate.

12. The method of claim 8 further comprising the step of providing means for generating a temporary access control identifier for transient parkers and means for paying the temporary access control identifier by said transient parkers.

13. The method of claim 12 further comprising the steps of validating said temporary access control identifier and reporting said validation to said centralized server.

14. The method of claim 12 wherein the means for paying a temporary access control identifier is a stand-alone payment terminal in electronic communication with said centralized server.

15. The method of claim 13 further comprising the steps of reporting each payment made to each said stand alone payment terminal, aggregating the totality of said payments to each said payment terminal, and providing payment to each garage structure owner equaling said payment totality.

16. The method of claim 8 comprising the additional steps of tracking monthly parker occupancy in each of said parking structures through each of said access control devices, determining the most recent use of a particular parking structure by a particular access control device user, and auditing that each of said access control devices are active and current.

17. A method of centralized parking management for at least one parking structure through an enterprise level system, the method comprising:
a) generating an identifier for each non-transient parker in each of said parking structures;
b) assigning each said identifier to an access control device;
c) tracking the usage of each access control device in each of said parking structures;
d) managing billing and collections of each of said non-transient parkers; and
e) generating a report of parking activities and revenues for said parking structure tenant.

18. The method of claim 17 further comprising the step of activating said access control device.

19. The method of claim 18 wherein each use of an access control device in an access control system at a parking facility is an access control event, comprising the further step of processing access control events through:
a) determining a monthly parking occupancy for each of the at least one parking structures;
b) updating a record for each access control device for the most recent use of said device in the parking structure; and
c) verifying that the access control device activation is synchronized between the enterprise-level control system and the access control system.

20. The method of claim 17 wherein each of said at least one parking structures has at least one means for generating a temporary access control identifier for transient parkers and at least one means for paying a temporary access control identifier by said transient parkers, comprising the additional steps of:
a) acknowledging entry of a transient parker into a parking structure through the generation of a temporary access control identifier;
b) calculating the length of stay and parking fee of said transient parker at said means for paying a temporary access control identifier;
c) collecting said parking fee at said parking payment means;
d) generating a coded paid parking entitlement; and
e) allowing parker egress from said parking facility upon presentation of said coded entitlement at an entry and exit control point.

21. The method of claim 20 further comprising the step of validating said temporary access control identifier prior to said calculating step.

22. The method of claim 20 further comprising the step of reporting all collected parking to said enterprise-level control system.

23. The method of claim 17 further comprising the steps of calculating the amount of taxes owed on said collections and generating a tax report.
